(19) United States
(12) Patent Application Publication
(10) Pub. No.: US 2016/0121244 A1
(43) Pub. Date: May 5, 2016

(54) A DISC FILTER APPARATUS

(71) Applicant: OUTOTEC (FINLAND) OY, Espoo (FI)

(72) Inventor: Hannu YLISIURUA, Lappeenranta (FI)

(73) Assignee: OUTOTEC (FINLAND) OY, Espoo (FI)

(21) Appl. No.: 14/894,186

(22) PCT Filed: May 27, 2014
(86) PCT No.: PCT/FI2014/050417

§ 371 Date: Nov. 25, 2015

(30) Foreign Application Priority Data
May 28, 2013 (FI) 20135574

(51) Int. Cl. B01D 33/23; B01D 33/80

(52) U.S. Cl. CPC B01D 33/23; B01D 33/803

(57) ABSTRACT

The disc filter apparatus comprises a drum that is rotatable around a shaft having a centre axis. The drum comprises filter discs positioned at an axial distance from each other. Each filter disc comprises a rim structure supported on the shaft and truncated, sector shaped filter plates mounted circumferentially in a radial plane to form an essentially continuous and planar disc surface. Each filter plate is attached with a fastening arrangement to the rim structure from a lower edge portion of the filter plate through at least three fastening points. The fastening arrangement between the filter plate and the rim structure comprises at each fastening point in the rim structure an adjustable sleeve construction. Prior art solutions require a radially planar fastening surface in the rim structure in order to have all the filter plates in one filter disc in the same radial plane. This is not necessary in the invention due to the use of an adjustable sleeve construction.

### FIELD OF THE INVENTION

The present invention relates to a disc filter apparatus according to the preamble of claim 1.

### BACKGROUND OF THE INVENTION

Filtration is a widely used process whereby a slurry or solid liquid mixture is forced through a media, with the solids retained on the media and the liquid phase passing through. Examples of filtration types include depth filtration, pressure and vacuum filtration, and gravity and centrifugal filtration.

Both pressure and vacuum filters are used in the dewatering of mineral concentrates. Pressure filtration is based on the generation of an overpressure within a filtration chamber. Consequently, solids are deposited onto the surface of the filter medium and filtrate flows through the filter medium into the filtrate channels. Pressure filters often operate in batch mode because continuous cake discharge is more difficult to achieve.

Vacuum filtration is based on producing a suction within the filtrate channels and thereby forming a cake of mineral on the surface of the filter medium. The most commonly used filter types for vacuum filters are filter cloths and ceramic filters. There exists several types of vacuum filters, ranging from belt filters to drums. The invention is, however, related to rotary vacuum disc filters.

Rotary vacuum disc filters are used for the filtration of relatively free filtering suspensions on a large scale, such as the dewatering of mineral concentrates. The dewatering of mineral concentrates requires large capacity in addition to producing a cake with low moisture content. The vacuum disc filter may comprise a plurality of filter discs arranged in line co-axially around a rotatable centre shaft. Each filter disc may be formed of a number of individual filter sectors, called filter plates, that are mounted circumferentially in a radial plane around the centre shaft to form the filter disc. Each filter plate is during each revolution of the shaft displaced for a certain period into a slurry basin situated below the shaft. The filter plate rises out of the basin when the revolution of the shaft proceeds. When the filter plate is submerged in the slurry basin a cake forms onto the surfaces of the filter plate due to the vacuum within the filter plate. Once the filter plate comes out of the basin, the pores are emptied as the cake is deliquored for a predetermined time which is essentially limited by the rotation speed of the disc. The cake can be discharged by a back-pulse of air or by scraping, after which the cycle begins again.

The filter plates are in prior art solution attached to a rim structure supported by spokes on the shaft of the drum. There are fastening points provided with holes in the lower portion of the filter plate. A fastening flange is positioned into each hole in the filter plate. The filter plate is fastened by bolts passing through the fastening flange in the lower portion of the filter plate. The filter plates are thus fastened directly to a side surface of the rim structure. This means that the rim structure must be machined to a high precision and spanned very precisly with the spokes on the shaft of the drum. The side surface of the rim structure that forms the fastening surface for the filter plates must be fully planar in a radial plane. A fully planar side surface in the rim structure is needed in order for the filter plates to form a planar filter surface. This solution is costly as it requires a set of special machinery and skills.

UK patent application 2 000 040 discloses a filter apparatus with a number of filter discs. An axially extending cylindrical drum forms a shaft of the filter apparatus. Each filter disc comprises a number of filter sectors extending outwards from the outer surface of the drum and forming an essentially continous planar disc surface at both side surfaces of the disc. Each filter sector comprises an axially extending filtrate discharge conduit attached to the outer surface of the drum, a collar assembly attached to filtrate discharge conduit and a truncated, sector shaped filter plate attached to the collar assembly. A plurality of elongated ribs extend within the filter plate between the filter surfaces between radially opposed end portions of the filter plate and are spaced apart to define a plurality of independent flow channels for filtrate drawn into the filter plate. The truncated radially inner end of the filter plate is attached to the radially outer end of the collar assembly with bolts. Each filter plate is attached with radially at both radial side surfaces of the filter plates extending bolts to the drum. These bolts pass in grooves between two adjacent filter plates and each bolt is provided with a bracket extending along the radially outer surface of two adjacent filter plates. The axial position of the filter plates on the drum is fixed.

### BRIEF DESCRIPTION OF THE INVENTION

An object of the present invention is to present a disc filter apparatus with an improved fastening arrangement for the filter plates.

The object of the invention is achieved by a fastening arrangement according to the independent claim 1. Preferred embodiments of the invention are disclosed in the dependent claims.

The disc filter apparatus comprises a drum that is rotatable around a shaft having a centre axis, the drum comprises a number of filter discs positioned in the axial direction at a distance from each other, each filter disc comprises a rim structure supported on the shaft and a number of individual, truncated, sector shaped filter plates mounted circumferentially in a radial plane to form an essentially continuous and planar disc surface, each filter plate is attached with a fastening arrangement to the rim structure from a lower edge portion of the filter plate through at least three fastening points. The fastening arrangement between the filter plate and the rim structure comprises at each fastening point in the rim structure an adjustable sleeve construction comprising an adjusting sleeve passing in the axial direction through a hole in the rim structure, said adjusting sleeve being lockable in a desired axial position in the axial hole in the rim structure, whereby the filter plate seats against an inner end surface of the adjusting sleeve when the filter plate is fastened to the rim structure, said inner surface of the adjusting sleeve determining a radial planar surface into which the filter plate is positioned when fastened to the rim structure through the adjustable sleeve construction, whereby axial adjustment of the position of the filter plate in relation to the rim structure is possible.

The filter plates can thus be positioned in the same radial plane by means of the adjustable sleeve construction. The requirements on the radial planarity of the side surface of the rim structure are thus much lower. The filter plates can regardless of the planarity of the side surface of the rim structure be postioned in the same radial plane by means of the adjustable sleeve construction.

The position of the outer surface of the adjustable sleeves can be ajusted by a simple laser beam. The laser beam determines a radial reference plane and the outer surface of each sleeve are adjusted so that it is in the radial reference plane. The adjustement of the sleeves can also be done with a developed 3D laser planarity measurement device. The outer surface of each sleeve is the surface against which the filter plate sets when the filter plate is fastened to the rim structure with the adjustable sleeves.

### BRIEF DESCRIPTION OF THE DRAWINGS

In the following the invention will be described in greater detail by means of example embodiments with reference to the accompanying drawings, in which

FIG. 1 is a perspective top view of a disc filter apparatus, wherein the invention may be applied,

FIG. 2 is a perspective top view of the drum of FIG. 1,

FIG. 3 is a radial cross section of one filter disc of the drum in FIG. 2,

FIG. 4 is a perspective view of a filter plate in the filter disc in FIG. 3,

FIG. 5 is a radial cross section of the rim structure of the filter disc in FIG. 4,

FIG. 6 is an exploded view of a prior art fastening arrangement for a filter plate,

FIG. 7 is an exploded view of an adjustable fastening arrangement according to the invention for a filter plate,

FIG. 8 is a cross section showing more in detail one embodiment of an adjustable fastening arrangement according to the invention for a filter plate,

FIG. 9 is a cross section showing more in detail a second embodiment of an adjustable fastening arrangement according to the invention for a filter plate.

FIG. 10 is a cross section showing the fastening arrangement in the filter plate more in detail.

### DETAILED DESCRIPTION OF EMBODIMENTS OF THE INVENTION

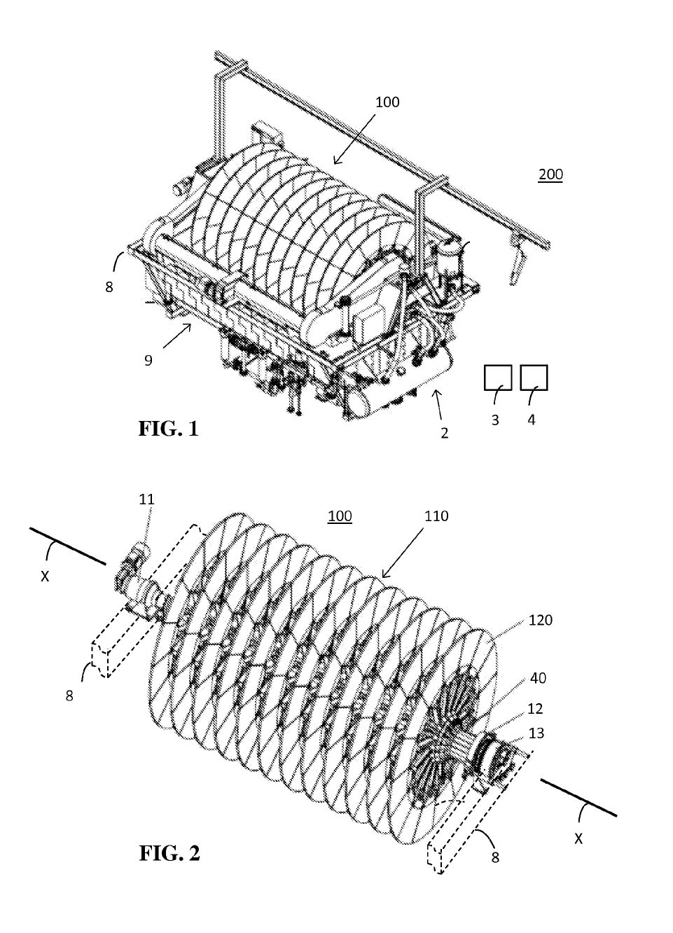

FIG. 1 is a perspective top view of a disc filter apparatus, wherein the invention may be applied. FIG. 2 is a perspective top view of the drum of FIG. 1.

The disc filter apparatus 200 comprises a cylindrical-shaped drum 100 that is supported by bearings 11 and 12 on a frame 8. The drum 100 is rotatable about a longitudial centre axis X-X such that a lower portion of the drum 100 is submerged in a slurry basin 9 located below the centre axis X-X. The drum 100 is rotated by a motor e.g. an electric motor through a gear box. The drum 100 comprises a plurality of ceramic filter discs 110 arranged in line co-axially around the centre axis X-X of the drum 100. The number of the ceramic filter discs 110 on the drum 100 may be in the range of 2 to 20. The diameter of each disc 110 may be in the range of 1.5 to 4 m.

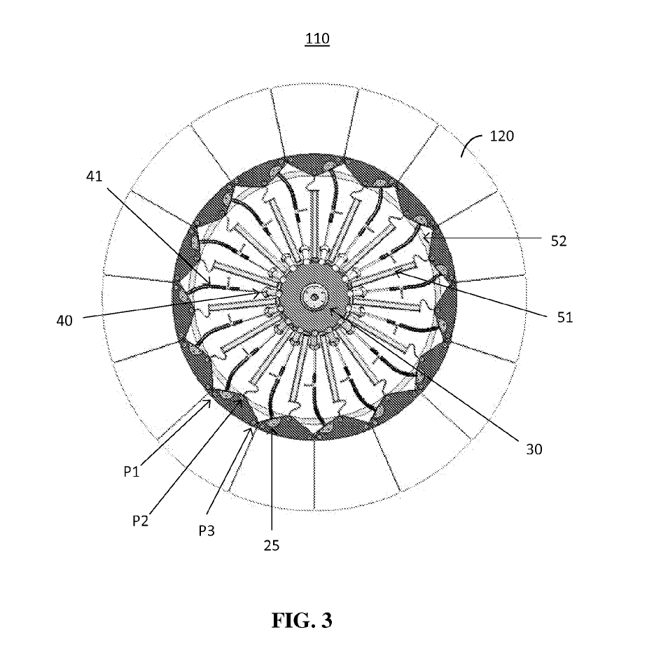

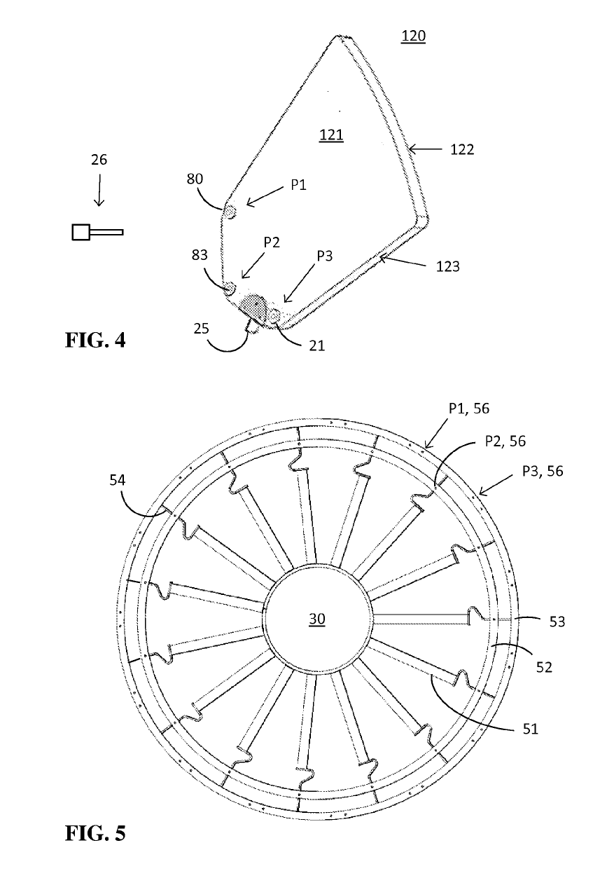

FIG. 3 is a radial cross section of one filter disc of the drum in FIG. 2. FIG. 4 is a perspective view of a filter plate in the filter disc in FIG. 3.

FIG. 5 is a radial cross section of the rim structure of the filter disc in FIG. 4.

The drum 100 comprises a shaft 30 and a rim structure 52, 53 supported by radial spokes 51 on the shaft 30. The rim structure 52, 53 comprises two concentric rims 52, 53 positioned at a radial distance from each other. There are radial support parts 54 between the rims 52, 53. The lower end of the spokes 51 are attached to the shaft 30 and the upper ends of the spokes 51 are attached to the inner rim 52. Each filter disc 110 is formed of a number of individual ceramic filter plates 120 having essentially the form of a truncated sector in a circle having the centre at the longitudinal centre axis X-X of the drum 100. The filter plates 120 are mounted circumferentially in a radial plane around the rim structure 52, 53 of the drum 100 to form an essentially continuous and planar disc surface. The number of filter plates 120 in one filter disc 110 may be in the range of 12 to 15.

Each filter plate 120 comprises a pair of opposite outwardly facing major faces 121, 122 interconnected by one or more edge faces 123. The major faces 121, 122 of the filter plate 120 are parallel and form planar suction walls through which water is sucked into the interior of the filter plate 120. The lower portion of each filter plate 120 is provided with fastening points P1, P2, P3 for attaching the filter plate 120 to the rim structure 52, 53 of the drum 100. Each fastening point P1, P2, P3 in the filter plate 120 is provided with a hole 21 passing through the filter plate 120.

There are corresponding fastening points P1, P2, P3 in the rims 52, 53 provided with holes 56 extending in the axial X-X direction through the rim 52, 53. The first rim 52 forms an inner rim and the second rim 53 forms an outer rim. The filter plates 120 can thus be attached to the rim structure 52, 53 with fastening bolts 26 passing through the holes 21 in the fastening points P1, P2, P3 in the filter plates 120. The fastening bolts 26 extend into corresponding holes 56 in the rim structure 52, 53. The fastening bolt 26 passing through the hole 21 in the lowermost fastening point P2 in the filter plate 120 is attached to a corresponding hole 56 in the first rim 52 and the fastening bolts 26 passing through the holes 21 in the uppermost fastening points P1, P3 of the filter plate 120 are attached to corresponding holes 56 in the second rim 53. The fastening points P1, P2, P3 of the filter plate 120 are positioned in the corners of a triangle standing on the tip. The lowermost fastening point P2 is situated at the tip and the uppermost fastening points P1, P3 are positioned in the upper corners of the triangle. This arrangement results in a solid fastening of the filter plate 120 to the rim structure 52, 53. An arrangement with three fastening points P1, P2, P3 is advantageous, but the number of fastening points P1, P2, P3 could naturally vary. There could be more than three fastening points.

The filter plate 120 is also provided with a mounting part 25, such as a tube connector 25, for providing a fluid duct from the interior of the the filter plate 120 to a collector piping 40 provided in the drum 100. Each filter plate 120 is connected to the collector piping 40 with hoses 41. The consecutive filter plates 120 in the different filter discs 110 in an axial X-X row form a group of filter plates. The filter plates 120 in each axial X-X group are advantageously connected to the same axially X-X extending collector pipe 40. The number of axially X-X extending collector pipes 40 in the drum 100 is thus the same as the number of filter plates 120 on one filter disc 110.

FIG. 2 shows that the collector pipes 40 are connected to a distributing valve 13 disposed on the shaft 30 of the drum 100. The distributing valve 13 transmits vacuum or overpressure to the filter plates 120. The distributing valve 13 may comprise zones such that a part of the filter plates 120 contain a higher vacuum or overpressure and a part of the filter plates 120 contain a lower vacuum or overpressure. If a long drum 100 is used, it can be advantageous to have a distributing valve 13 at both ends of the drum 100. The vacuum system comprises a filtrate tank 2, a vacuum pump 3 and a filtrate pump 4. The vacuum pump 3 maintains vacuum in the collector piping 40 and the filtrate pump 4 removes the filtrate from the collector piping 40. It is possible to arrange reverse flushing or backwash so that some of the filtrate or clean water from an external water source is led back to the collector piping 40 by means of a backwash system, such as a backwash pump.

As the row of the filter discs 110 rotate, the filter plates 120 of each disc 110 move into and through the basin 9. Each filter plate 120 goes through different process phases during one revolution of the disc 110. In a cake forming phase, the liquid is passing through the outer surfaces of the filter plate 120 into the interior of the filter plate 120 when it travels through the slurry, and a cake is formed on the opposite outer surfaces of the filter plate 120. The filter plate 120 enters the cake drying phase after it leaves the basin 9. If cake washing is required, it is done in the beginning of the drying phase. In the cake discharge phase the cake is scraped off from the outer surfaces of the filter plate 120 by ceramic scrapers so that a thin cake is left on the outer surfaces of the filter plate 120. There is thus a small gap between the scraper and the outer surface of the filter plate 120. In the backflush or backwash phase of each rotation, water (filtrate) is pumped in a reverse direction from the inside of the filter plate 120 through the filter plate 120 to the outside of the filter plate 120. The backflush water washes off the residual cake and cleans the pores of the filter plate 120.

FIG. 6 is an exploded view of a prior art fastening arrangement of a filter plate. Each filter plate 120 is fastened directly through the upper fastening points P1 and P3 in the filter plate 120 to the outer rim 53 and through the lower fastening point P2 in the filter plate 120 to the inner rim 52. The fastening is achieved with fastening bolts 26 passing in the axial X-X direction through the holes 21 in the fastening points P1, P2, P3 in the filter plate 120. The outer ends of the fastening bolts 26 have an outer threading. There are fastening points P1, P2, P3 in the filter rim structure 52, 53 corresponding to the fastening points P1, P2, P3 in the filter plate 120. The fastening points P1, P2, P3 in the rim structure 52, 53 comprises holes 56 extending in the axial direction X-X through the rim structure 52, 53. The holes 56 are provided with an inner threading. The fastening bolts 26 can thus be screwed into the threads in the holes 56 in the rim structure 52, 53. A first outer surface 121 of the filter plate 120 will thus set against a first side surface 52A, 53A of the rim structure 52, 53. The first side surface 52A, 53A of the rim structure 52, 53 should form a planar radial plane. The planar fastening plane 52A, 53A is needed in order to secure that all the filter plates 120 in one filter disc 110 are positioned in the same radial plane.

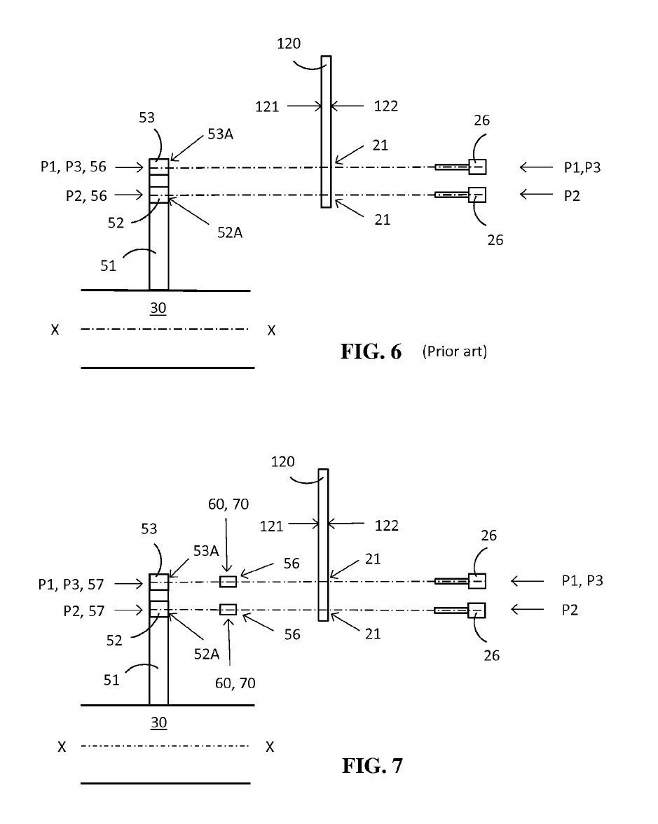

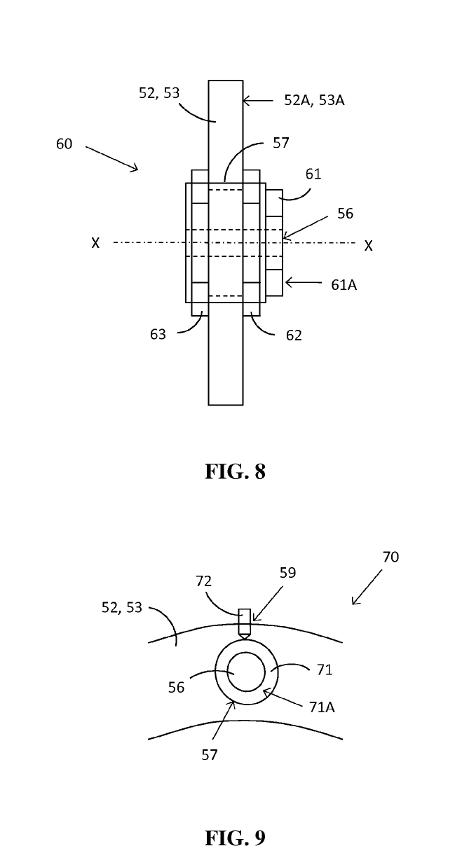

FIG. 7 is an exploded view of an adjustable fastening arrangement according to the invention for a filter plate. Each filter plate 120 is fastened through the upper fastening points P1 and P3 to the outer rim 53 and through the lower fastening point P2 to the inner rim 52. The fastening is achieved with fastening bolts 26 passing through the holes 21 in the fastening points P1, P2, P3 in the filter plate 120. The fastening arrangement is, however, based on an adjustable sleeve construction 60, 70 in each fastening point P1, P2, P3 in the rim structure 52, 53. The adjustable sleeve construction 60, 70 is attached to a hole 57 passing in the axial X-X direction through the rim structure 52, 53. The adjustable sleeve construction 60, 70 can be locked to the rim structure 52, 53 in different axial X-X positions. The adjustable sleeve construction 60, 70 comprises a hole 56 passing through the centre of the sleeve construction 60, 70. The hole 56 comprises an inner threading for receiving the outer end of the fastening bolt 26. The first side surface 121 of the filter plate 120 will seat against the end surface of the adjustable sleeve construction 60, 70 when the filter plate 120 is fastened with the bolts 26 to the adjustable sleeve construction 60. The position of the filter plate 120 will thus depend on the axial position of each of the three adjustable sleeve constructions 60, 70 in the fastening points P1, P2, P3. When all the three adjustable sleeve constructions 60, 70 are in the same radial plane, then also the filter plate 120 is in the same radial plane.

FIG. 8 is a cross section showing more in detail one embodiment of an adjustable fastening arrangement according to the invention for a filter plate. The adjustable sleeve construction 60 comprises an adjusting sleeve 61 passing in the axial X-X direction through a hole 57 in the rim structure 52, 53. The adjusting sleeve 61 comprises an outer threading and the hole 57 comprises an inner threading. The adjusting sleeve 61 can thus be screwed into the hole 57 into a desired axial X-X position. There are locking nuts 62, 63 at both sides of the rim structure 52, 53. The locking nuts 62, 63 have an internal threading so that the locking nuts 62, 63 can be threaded on the adjusting sleeve 61. The adjusting sleeve 61 can thus be locked to the rim 52, 53 in a desired position in the axial X-X direction. The inner surface 61A of each adjusting sleeve 61 positioned in the holes 56 in the rim structure 52, 53 can thus be positioned at a desired axial X-X position. The inner surfaces 61A of all the three adjusting sleeves 60 can thus be positioned in the same radial plane. The filter plate 120 is fastened to the adjusting sleeves 61 by fastening bolts 26 passing through the holes 83 in the flange construction 80 in the filter plate 120. The adjusting sleeve 61 comprises an axial X-X hole 56 in the centre of the adjusting sleeve 61. The hole 56 comprises an inner threading receiving the outer threading of the fastening bolt 26. The first outer side surface 121 of the filter plate 120 will be seated against the inner surface 61A of the three adjusting sleeves 61 when the filter plate 120 is attached with the fastening bolts 26 to the adjusting sleeves 61. The filter plate 120 will thus be positioned in a radial plane as the inner surfaces 61A of all the three the adjusting sleeves 60 are positioned in the same radial plane.

FIG. 9 is a cross section showing more in detail a second embodiment of an adjustable fastening arrangement according to the invention for a filter plate. The adjustable sleeve construction 70 comprises an adjusting sleeve 71 passing in the axial X-X direction through a hole 57 in the rim structure 52, 53. The adjusting sleeve 71 comprises an outer threading and the hole 57 comprises an inner threading. The adjusting sleeve 71 can be screwed into the hole 57 into a desired axial X-X position. There is a locking screw 72 passing in the radial direction through a hole 59 in the rim 52, 53 from a radial outer surface of the rim structure 52, 53 to the axial X-X hole 57 in the rim structure 52, 53. The locking screw 72 has an outer threading and the hole 59 has an inner threading. The adjusting sleeve 71 can thus be locked with the locking screw 72 in a desired axial X-X position in the hole 57 in the rim 52, 53. The adjusting sleeve 71 comprises an axial X-X hole 56 in the centre of the adjusting sleeve 71. The hole 56 comprises an inner threading receiving the outer threading of the fastening bolt 26. The first side surface 121 of the filter plate 120 will be seated against the inner surface 71A of the three adjusting sleeves 71 when the filter plate 120 is attached with the fastening bolts 26 to the adjusting sleeves 71. The filter plate 120 will thus be positioned in a radial plane as the inner surfaces 71A of all the three the adjusting sleeves 70 are positioned in the same radial plane.

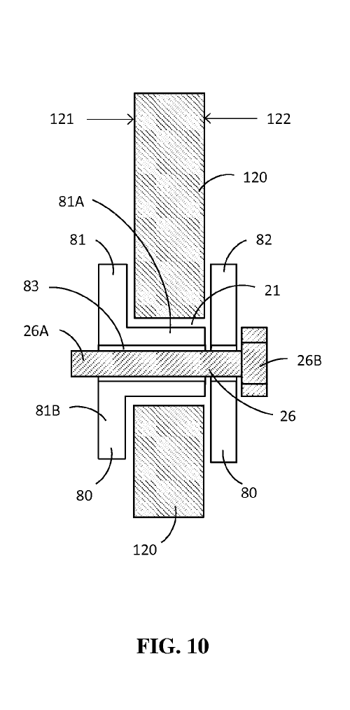

FIG. 10 is a cross section showing the fastening arrangement in the filter plate more in detail. The fastening arrangement in the filter plate 120 comprises advantageously a flange construction 80 attached to the filter plate 120. The flange construction 80 comprises a first part 81 and a second part 82. The first part 81 comprises a first portion 81A extending into the hole 21 in the filter plate 120 and a second portion 81B seating against the first surface 121 of the filter plate 120. The first portion 81A of the first part 81 has essentially the form of a cylinder and the second portion 81B of the first part 81 has essentially the form of a collar. The second part 82 is seated against the second surface 122 of the filter plate 120. The second part 82 has essentially the form of a collar. A hole 83 passes through the first part 81 and the second part 82 of the flange construction 80. The fastening bolt 26 passes through the hole 83 in the flange construction 80 so that an outer end 26B of the bolt 26 seats against the outer surface of the second part 82 of the flange construction 80. The inner end 26A of the bolt 26 comprises an outer threading and can be threaded into the inner threading in a corresponding hole 56 in the adjusting sleeve 61, 71.

In embodiments described herein, a material to be filtered is referred to as a slurry, but embodiments of the invention are not intended to be restricted to this type of fluid material. The slurry may have high solids concentration, e.g. base metal concentrates, iron ore, chromite, ferrochrome, copper, gold, cobalt, nickel, zinc, lead and pyrite.

Upon reading the present application, it will be obvious to a person skilled in the art that the inventive concept can be implemented in various ways. The invention and its embodiments are not limited to the examples described above but may vary within the scope of the claims.

1-8. (canceled)

9. A disc filter apparatus comprises a drum that is rotatable around a shaft having a centre axis, the drum comprises a number of filter discs positioned in the axial direction at a distance from each other, each filter disc comprises a rim structure supported on the shaft and a number of individual, truncated, sector shaped filter plates mounted circumferentially in a radial plane to form an essentially continuous and planar disc surface, each filter plate is attached with a fastening arrangement to the rim structure from a lower edge portion of the filter plate through at least three fastening points, wherein the fastening arrangement between the filter plate and the rim structure comprises at each fastening point in the rim structure an adjustable sleeve construction comprising an adjusting sleeve passing in the axial direction through a hole in the rim structure, said adjusting sleeve being lockable in a desired axial position in the axial hole in the rim structure, whereby the filter plate seats against an inner end surface of the adjusting sleeve when the filter plate is fastened to the rim structure, said inner surface of the adjusting sleeve determining a radial planar surface into which the filter plate is positioned when fastened to the rim structure through the adjustable sleeve construction, whereby axial adjustment of the position of the filter plate in relation to the rim structure is possible.

10. A disc filter apparatus according to claim 9, wherein the adjustable sleeve construction comprises further two locking nuts at each side surface of the rim structure, said locking nuts being threaded on the adjusting sleeve in order to lock the adjusting sleeve in a desired position in the axial hole in the rim structure.

11. A disc filter apparatus according to claim 9, wherein the adjustable sleeve construction comprises further a locking screw passing in a radial hole through the rim structure into the axial hole in the rim structure, said locking screw locking the adjusting sleeve in a desired position in the axial hole in the rim structure.

12. A disc filter apparatus according to claim 9, wherein the fastening arrangement comprises three fastening points in the lower edge portion of the filter plate, said fastening points being in the corners of a triangle standing on the tip, the lowermost fastening point being positioned on a radial centre line of the filter plate, each fastening point comprising a flange construction and a hole passing through the flange construction and thus also through the filter plate in the axial direction.

13. A disc filter apparatus according to claim 12, wherein the fastening arrangement comprises a fastening bolt passing through the hole in the fastening flange construction in the filter plate, an outer threading of the fastening bolt being received by an inner threading in the hole in the adjusting sleeve, whereby the fastening bolt presses the filter plate against the inner surface of the adjusting sleeve when the fastening bolt is tightened.

14. A disc filter apparatus according to claim 9, wherein the rim structure comprises an inner rim and an outer rim, which are concentric and positioned at a radial distance from each other.

15. A disc filter apparatus according to claim 14, wherein the filter plate is attached through two fastening points at the outer rim and through one fastening point at the inner rim, said two fastening points being at the same radial distance from the centre axis.
